(19) United States
(12) Patent Application Publication
(10) Pub. No.: US 2023/0115684 A1
(43) Pub. Date: Apr. 13, 2023

(54) METHODS AND SYSTEMS FOR USING NON-FUNGIBLE BLOCKCHAIN TOKENS (NFTS) FOR ADDING VALUE TO PHYSICAL PRODUCTS

(71) Applicant: nicholas JUNTILLA, los angeles, CA (US)

(72) Inventor: nicholas JUNTILLA, los angeles, CA (US)

(21) Appl. No.: 17/894,132

(22) Filed: Aug. 23, 2022

Related U.S. Application Data
(63) Continuation-in-part of application No. 17/020,820, filed on Sep. 15, 2020.
Application No. 17/020,820 is a continuation-in-part of application No. 16/669,962, filed on Oct. 31, 2019.
Application No. 16/669,962 is a continuation of application No. 16/504,317, filed on Jul. 7, 2019, now abandoned.
(60) Provisional application No. 63/235,806, filed on Aug. 23, 2021.
(60) Provisional application No. 62/694,603, filed on Jul. 6, 2018.

(51) Int. Cl. G06Q 20/38; G06Q 20/32; G06Q 30/018

(52) U.S. Cl. CPC G06Q 20/389; G06Q 20/3276; G06Q 20/3278; G06Q 30/0185; G06Q 2230/00

(57) ABSTRACT

In one aspect, a computerized-method for utilizing a non-fungible token (NFT) to provide information security of an item includes the step of preauthorizing a validity check of an identity of the item with a Matrix code. There is a single owner of the Matrix code. The single owner approves an inquiry into whether the Matrix code comprises an original Matrix code. The method includes authorizing an NFT based on the Matrix code; assigning the NFT to the Matrix code. The NFT is used to validate the authenticity of the item. The method includes implementing an NFT update. The NFT update comprises a condition of the item, a maintenance state of the item; a historical importance of the item; an evaluation of the NFT, and an individual nostalgia value of the item. The method includes implementing an NFT voting schema.

### CLAIM OF PRIORITY

This application claims priority to U.S. Provisional Application No. 63/235,806, filed on Aug. 23, 2021, and titled METHODS AND SYSTEMS FOR USING NON-FUNGIBLE BLOCKCHAIN TOKENS (NFTS) FOR ADDING VALUE TO PHYSICAL PRODUCTS. This provisional patent application is hereby incorporated by reference in its entirety.

This application claims priority to and is a continuation in part of U.S. application Ser. No. 17/020,820 is a Continuation in-part of, filed on Apr. 15, 2021 and titled TEXT MESSAGING APPLICATION, DATABASE AND SYSTEM FOR AUTOMATED VERIFICATION OF PRODUCT AUTHENTICITY. This patent application is hereby incorporated by reference in its entirety.

U.S. application Ser. No. 17/020,820 claims priority from and is a continuation in part of U.S. patent application Ser. No. 16/669,962, titled METHODS AND SYSTEMS FOR TRACKING OWNERSHIP OF GOODS WITH A BLOCKCHAIN and filed on Oct. 31, 2019. This application is hereby incorporated by reference in its entirety.

U.S. application Ser. No. No. 16/669,962 claims priority from and is a continuation of U.S. patent application Ser. No. 16/504,317, titled METHODS AND SYSTEMS FOR TRACKING OWNERSHIP OF GOODS WITH A BLOCKCHAIN and filed on Jul. 7, 2019. This application is hereby incorporated by reference in its entirety.

U.S. application Ser. No. 16/504,317 claims priority from U.S. provisional patent application No. 62/694,603, titled METHODS AND SYSTEMS FOR TRACKING OWNERSHIP OF GOODS WITH A BLOCKCHAIN and filed on Jul. 6, 2018. This provisional application is hereby incorporated by reference in its entirety.

### BACKGROUND

Blockchains have enabled the authentication of various products. Accordingly, improvements to non-fungible blockchain tokens (NFTs) for adding value to physical products are desired.

### SUMMARY OF THE INVENTION

In one aspect, a computerized-method for utilizing a non-fungible token (NFT) to provide information security of an item includes the step of preauthorizing a validity check of an identity of the item with a Matrix code. There is a single owner of the Matrix code. The single owner approves an inquiry into whether the Matrix code comprises an original Matrix code. The method includes authorizing an NFT based on the Matrix code; assigning the NFT to the Matrix code. The NFT is used to validate the authenticity of the item. The method includes implementing an NFT update. The NFT update comprises a condition of the item, a maintenance state of the item; a historical importance of the item; an evaluation of the NFT, and an individual nostalgia value of the item. The method includes implementing an NFT voting schema. Each owner of the NFT counts for a vote or portion of a vote in order to make a decision for a community related to the NFT. The method includes creating a NFT community a set of owners of the items. The method includes implementing single sign on NFT, A user uses the NFT to login into an NFT transfer system that transfer the NFT to another user. Once a first user transfers the NFT to the other user, the first user can no longer log into the NFT transfer system. The method includes using the NFT for pre-selling the item. The NFT is sold to the other user in advance and the item is sold to the other user.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for using NFTS for adding value to physical products, according to some embodiments.

FIG. 2 illustrates an example screen shot of pseudo-code useful for using NFTS for adding value to physical products, according to some embodiments.

FIG. 3 depicts an exemplary computing system that can be configured to perform any one of the processes provided herein.

The Figures described above are a representative set and are not an exhaustive with respect to embodying the invention.

### DESCRIPTION

Disclosed are a system, method, and article of manufacture for using NFTs for adding value to physical products. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Blockchain can be a continuously growing list of records (e.g. blocks), which are linked and secured using cryptography. Each block typically contains a cryptographic hash of the previous block, a timestamp, and transaction data.

Non-fungible token (NFT) is a unit of data stored on a digital ledger (e.g. a blockchain, etc.) that certifies a digital asset to be unique and therefore not interchangeable. Near-Field Communication (NFC) is a set of communication protocols for communication between two electronic devices over a distance of 4 cm (1½ in) or less.[1] NFC offers a low-speed connection with simple setup that can be used to bootstrap more-capable wireless connections.

Matrix barcode, two-dimensional barcode, as opposed to linear and stacked symbologies.

Quick Response code (QR) code is a type of matrix barcode (and/or two-dimensional barcode, etc.).

Smart contract is a computer program or a transaction protocol which is intended to automatically execute, control or document legally relevant events and actions according to the terms of a contract or an agreement.

### Example Systems and Methods

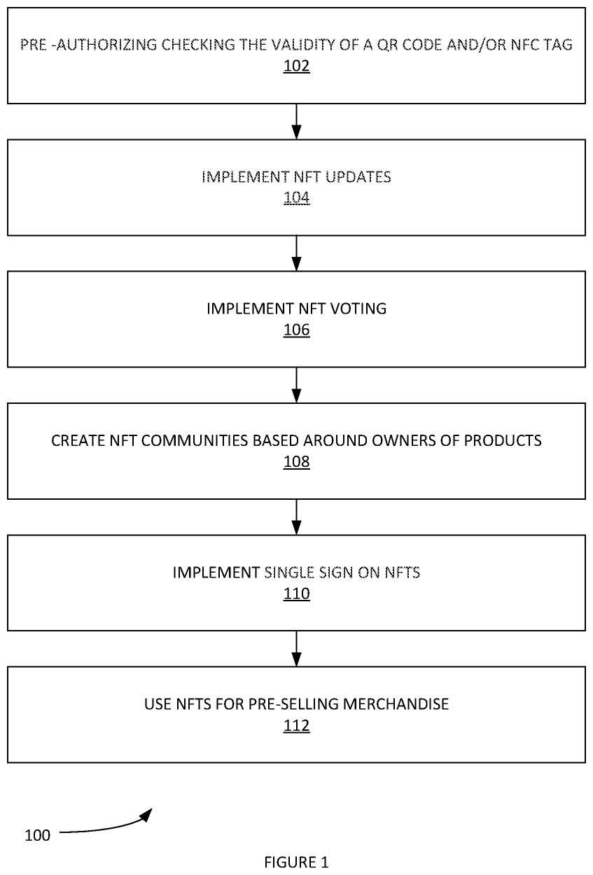

FIG. 1 illustrates an example process 100 for using NFTs for adding value to physical products, according to some embodiments. It is noted the NFTs can be used in lieu of QR codes (and/or other matrix codes) in various embodiments provided herein.

In step 102, process 100 can do pre -authorizing checking the validity of a OR code and/or NFC tag. Authorization of an NFT based on a QR code is covered in the earner patent, but this added pre-authorization, which means rather than sending a text message to the owner, the owner can pre-authorize a test so that an account may scan a QR code within a window of time and get an automatic pass. It is difficult to know that a OR code attached to a product is the original code or a copy of that code. By using this test one can determine that the OR code is the original and not a copy. An NFT may be assigned to a OR code. In this way a NFT may be used to validate the authenticity of a product. The method for determining whether a OR code is the original and not a copy is as follows. There is one owner of the OR code. That owner can approve inquiries into whether it is the original OR code. Those queries can be done using a computer system in person or remotely using pre-authorization.

Use case examples are now provided. In one example, a user may wish to test that a QR code sent to them is an original QR code. The owner of the QR code to pre-authorize their account so that when the requester scans it, they will receive a passed test notification. The act of pre-authorization may be entering the requester's user account number into a field on the website or scanning a QR code from the requester. The request may now have a day or some reasonable amount of time to scan the original QR code and receive the passed result.

In step 104, process 100 can implement NFT updates. An NFT may be updated. This increases the value of the NFT. Updates can be such as to the condition of the item or important events that the item was involved in. This information may be stored in a centralized database or in a smart contract on the blockchain. This information can include, inter alia: a condition of the item; a maintenance state of the item; a historical importance of the item; an evaluation of the NFT such as noted by a third-party auditor; an individual nostalgia value; etc.

In step 106, process 100 can enable an NFT to be used for voting. This can be an NFT voting schema. For example, each owner of an NFT can count for a vote or portion of a vote in order to make a decision for a community related to the NFT.

In one example, an NFT can be used for insurance, warranties, and recalls. Inventories can be taken for insurance. Dates and Times of purchases can be validated on the blockchain. Customers can be contacted about recalls and recall information can be updated on the blockchain.

In step 108, process 100 can create NFT communities based around owners of products. An NFT may be used to create a community for collectibles. A community can communicate with each other and brands may communicate with the community. Step 108 can utilize functionalities that support NFT based messaging, emails and chat rooms for brands and influencers, etc. Additionally, a virtual private network can be based on an NFT.

In step 110, process 100 can implement single sign on NFTs. The ownership of an NFT used for a physical product can also be used as a login for a computer system. For example, given a computer system that uses an NFT to login when a user transfers an NFT to another use the first owner can no longer log in to that system and the new owner can log into the system.

In step 112 NFTs can be used for preselling merchandise. For example, an NFT may be sold in advance and the physical product can be granted after it is sold.

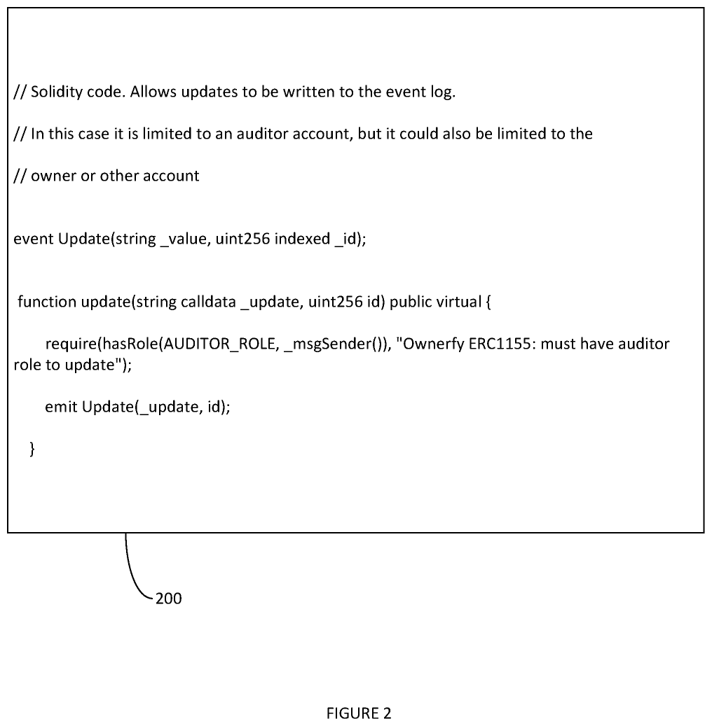

FIG. 2 illustrates an example screen shot 200 of pseudo-code useful for using NFTS for adding value to physical products, according to some embodiments. As shown, the pseudo-code illustrates example solidity code that can be in a functioning smart contract that allows for blockchain updates to NFTs.

### Additional Example Computer Architecture and Systems

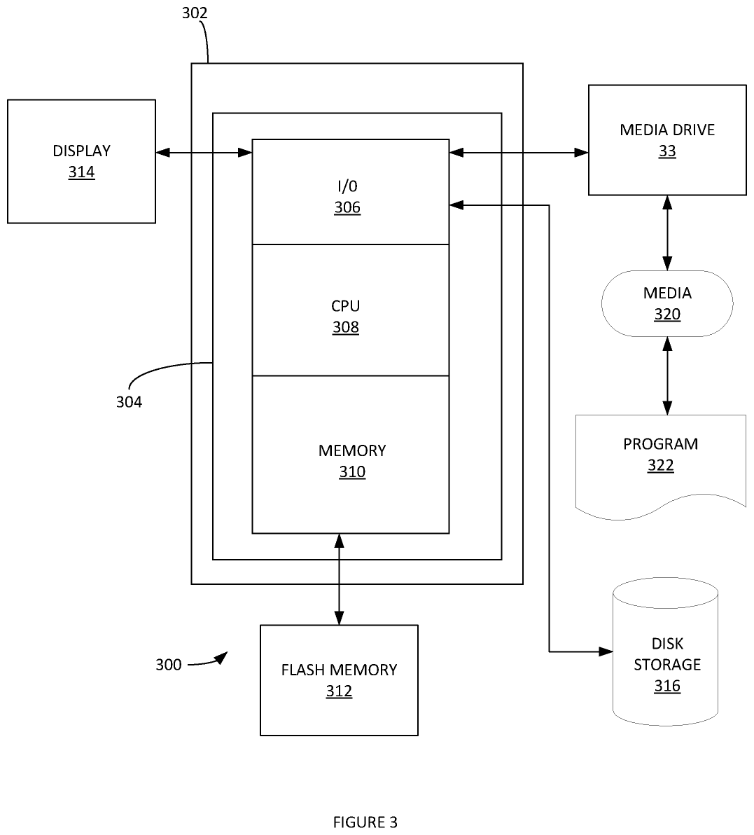

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A computerized-method for utilizing a non-fungible token (NFT) to provide information security of an item comprising:
preauthorizing a validity check of an identity of the item with a Matrix code, wherein there a single owner of the Matrix code, wherein the single owner approves an inquiry into whether the Matrix code comprises an original Matrix code;
authorizing an NFT based on the Matrix code;
assigning the NFT to the Matrix code, wherein the NFT is used to validate the authenticity of the item;
implementing an NFT update, wherein the NFT update comprises a condition of the item; a maintenance state of the item; a historical importance of the item, an evaluation of the NFT; and an individual nostalgia value of the item;
implementing an NFT voting schema, wherein each owner of the NFT counts for a vote or portion of a vote in order to make a decision for a community related to the NFT;
create a NFT community a set of owners of the items;
implementing single sign on NFT, wherein a user uses the NFT to login into an NFT transfer system that transfer the NFT to another user, wherein once a first user transfers the NFT to the other user, the first user can no longer log into the NFT transfer system; and
using the NFT for pre-selling the item, wherein the NFT is sold to the other user in advance and the item is sold to the other user.

2. The computerized method of claim 1, wherein the NFT comprises a unit of data stored on a digital ledger that certifies a digital the unit of data to be unique and therefore not interchangeable.

3. The computerized method of claim 1, wherein a Matrix code and a near-field communication (NFC) tag are used to perform the validity check of the identity of the item.

4. The computerized method of claim 3, wherein the Matrix code comprises a QR code.

5. The computerized method of claim 4, wherein the user pre-authorizes a test so that an account must scan the QR code within a window of time.

6. The computerized method of claim 5, wherein the test determines that the QR code is the original and not a copy of the QR code.

7. The computerized method of claim 1, wherein the NFT update is stored in a centralized database or in a smart contract on a computerized blockchain.

8. The computerized method of claim 1, wherein a private network enables the set of owners to electronically communicate about the item.
